(19) United States
(12) Patent Application Publication
(10) Pub. No.: US 2006/0284410 A1
(43) Pub. Date: Dec. 21, 2006

(54) Bill processing device

(76) Inventors: Yukio Ito, Saitama-ken (JP); Nobuyuki Iida, Saitama-ken (JP); Noboru Yamagishi, Saitama-ken (JP)

Correspondence Address: FISH & RICHARDSON P.C., P.O. BOX 1022, MINNEAPOLIS, MN, 55440-1022, US

(21) Appl. No.: 11/431,253

(22) Filed: May 9, 2006

(30) Foreign Application Priority Data
Jun. 6, 2005 (JP) 2005-165521

(51) Int. Cl. B42D 15/00

(52) U.S. Cl. 283/67

(57) ABSTRACT

A bill processing device to prevent drawing-out of a bill with a simple structure is provided. In a bill processing device having a bent bill path, a long channel along a conveying direction of a bill is provided on a path surface that forms the bill path and is bent to be convex, a plurality of the long channels are provided in parallel in a transverse direction of the bill path, projections extending from respective side walls or bottom surfaces of the plurality of long channels are included, and the projections each have a first surface inclined to a bottom surface side of the long channel to guide a string-shaped or band-shaped foreign matter conveyed with a bill to enter the long channel, and a second surface horizontal or inclined to the bottom surface side of the channel to inhibit the foreign matter which has entered the long channel from exiting from the long channel.

### BACKGROUND OF THE INVENTION

1. Field of the Invention

The present invention relates to a bill processing device which is fitted into an apparatus such as an automatic vending machine, a money changer and a gaming machine, discriminates authenticity of inputted bills, and stores authentic bills, and particularly relates to a bill processing device which prevents a mischievous act of drawing out the inputted bills.

2. Related Background Art

Conventionally, a bill processing device used in each of the above described apparatuses has suffered from such a mischievous act as drawing out authentic bills after the inputted bills are determined as the authentic bills.

The bills are drawn out in such a way that a foreign matter such as a tape is stuck to the rear end of an inputted bill, and after the inputted bill is determined as an authentic bill, the inputted bill is drawn out of the bill input port by pulling the string member.

In opposition to such a mischievous act, the conventional bill processing device has been provided with various kinds of prevention means regarding drawing-out of bills as shown in (1) to (4).

(1) The means that utilizes an optical sensor of a discrimination part which discriminates authenticity of bills, detects reduction in the transmission level of the optical sensor after a tape passes, and thereby determines whether a tape is stuck to the inputted bill or not, and returns the inputted bill when detecting the tape.
(2) The means that provides in a bill path a tape detecting lever and a tape detecting hole in which the tape detecting lever is inserted, detects that the tape detecting lever does not enter the detecting hole after a bill passes by means of an optical sensor in the tape detecting hole, and thereby detects the presence of a tape and returns the inputted bill.
(3) The means which provides in a bill path shutter means consisting of a lever and a hole in which the lever is inserted, blocks the bill path when the inputted bill is regarded as an authentic bill, and thereby prevents the inputted bill from being drawn out.
(4) The means that forms long channels in a bent portion, in a bill processing device in which the bent portion is formed in a bill path, the means that further includes a cutter member in a bill chute, and thereby prevents drawing-out of the bills, and the like.

The above described bill drawing-out prevention means which are fitted in the conventional bill processing device have the following problems.

Namely, concerning (1), when the tape stuck to the rear end of the inputted bill does not pass the optical sensor of the discrimination part, namely, when the tape is stuck to a bill in the position avoiding the optical sensor, presence and absence of the tape cannot be detected.

Concerning (2), when the tape stuck to the rear end of the inputted bill does not pass the tape detecting lever, namely, when the tape is stuck to a bill in the position avoiding the tape detecting lever, the presence and absence of the tape cannot be detected. In the case of a soft tape, the tape gets under the detecting lever, and in this case, presence and absence of the tape cannot be detected, either.

In the case of the shutter mechanism of (3), the structure itself is complicated with a large number of components, and requires a large space, thus causing the disadvantage of the bill processing device becoming expensive. The bill drawing-out prevention means using the lever has the same disadvantage.

Further, in the case of using the structure of simply forming the long channels of (4), against the illegal act using a string-shaped thing thinner than the slit width, or using a band-shaped thing narrower than the slit width, the string or the band is not held in the slit, and therefore, the string or the band may not be held by the frictional force, allowing the illegal act of drawing out bills. Installation of the cutter member has the problem in view of cost and safety.

### SUMMARY OF THE INVENTION

The present invention is made in view of the above circumstances, and has an object to provide a bill processing device which prevents drawing-out of bills with a simple structure.

In order to attain the above-described object, in the present invention, in a bill processing device having a bent bill path, a long channel along a conveying direction of a bill is provided on a path surface that forms the bill path and is bent to be convex, a plurality of the long channels are provided in parallel in a transverse direction of the bill path, projections extending from respective side walls or bottom surfaces of the plurality of long channels are included, and the projections are each designed to have a first surface inclined to a bottom surface side of the long channel to guide a string-shaped or band-shaped foreign matter conveyed with a bill to enter the long channel, and a second surface horizontal or inclined to the bottom surface side of the channel to inhibit the foreign matter which has entered the long channel from exiting from the long channel.

In a bill processing device having a bent bill path, a long channel along a conveying direction of a bill is provided on a path surface that forms the bill path and is bent to be convex, a plurality of the long channels are provided in parallel in a transverse direction of the bill path, projections extending from respective side walls or bottom surfaces of the plurality of long channels are included, and the projections are each designed to have a first surface inclined to a bottom surface side of the long channel to guide a string-shaped or band-shaped foreign matter conveyed with a bill to enter the long channel, and a second surface horizontal or inclined to the bottom surface side of the channel to inhibit the foreign matter which has entered the long channel from exiting from the long channel. Therefore, for the mischievous action of sticking a string-shaped or band-shaped foreign matter to a bill, the string-shaped or band-shaped foreign matter is not guided to the bill path, and therefore, an illegal act such as drawing-out of a bill can be prevented.

### BRIEF DESCRIPTION OF THE DRAWINGS

FIG. 1A is a general view of a bill processing device in accordance with the present invention;

FIG. 1B is a general sectional view of the bill processing device in accordance with the present invention;

FIG. 2 is an enlarged view of a main part of FIG. 1B;

FIG. 3 is an enlarged view of a main part of FIG. 1B;

FIG. 4 is an enlarged view of a main part of FIG. 1B;

FIG. 5A is an enlarged view of a main part showing an illustrative projection member in accordance with the present invention;

FIG. 5B is a view of the illustrative projection member seen in the direction of the arrow A shown in FIG. 5A;

FIG. 6A is an enlarged view of a main part showing an illustrative projection member in accordance with the present invention;

FIG. 6B is a view of the illustrative projection member seen in the direction of the arrow B shown in FIG. 6A;

FIG. 6C is a view of an illustrative projection member seen in the direction of the arrow B shown in FIG. 6A;

FIG. 7A is an enlarged view of a main part showing an illustrative projection member in accordance with the present invention;

FIG. 7B is a view of the illustrative projection member seen in the direction of the arrow C shown in FIG. 7A;

FIG. 7C is a view of the illustrative projection member seen in the direction of the arrow C shown in FIG. 7A;

FIG. 8 is an enlarged view of a main part showing an arrangement of illustrative projection members in accordance with the present invention;

FIG. 9 is an enlarged view of a main part showing an arrangement of illustrative projection members in accordance with the present invention;

FIG. 10A is an enlarged view of a main part showing an illustrative projection member in accordance with the present invention;

FIG. 10B is a view of the illustrative projection members seen in the direction of the arrow D shown in FIG. 10A; and

FIG. 10C is a view of an illustrative projection member seen in the direction of the arrow D shown in FIG. 10A.

### DESCRIPTION OF THE PREFERRED EMBODIMENTS

Hereinafter, an embodiment of a bill processing device according to the present invention will be described in detail.

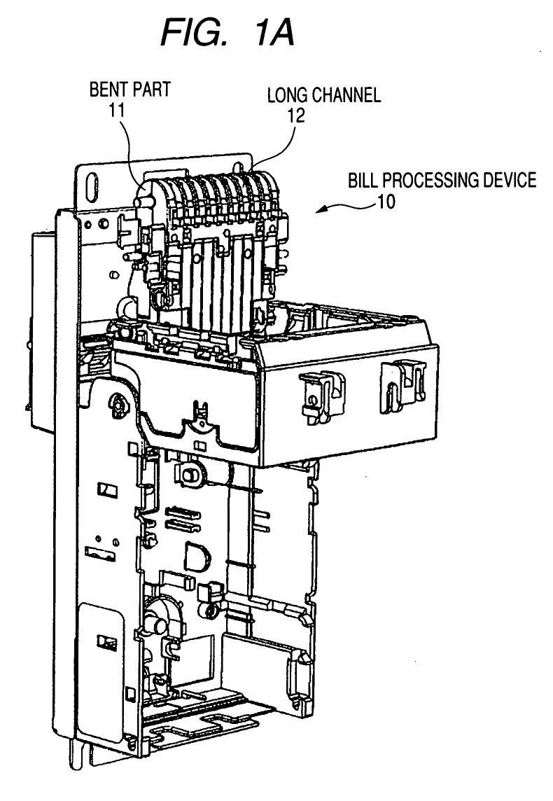

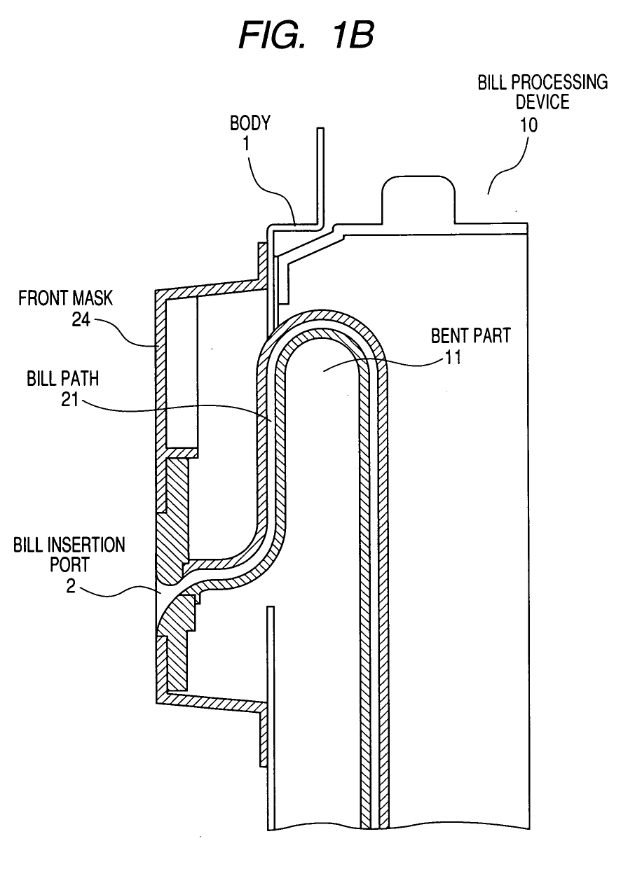

FIG. 1A is a general view of a bill processing device 10 according to the present invention, which shows the shape of a bill path 21 disposed in a bill discrimination part by especially removing an authentic bill storing stacker placed on a back surface of the device body and rotating the bill discrimination part. The bill path 21 has a bent part 11 that is bent to be convex inside the bill processing device 10, and a plurality of long channels 12 are formed along a bill conveying direction in the bent part 11.

FIG. 1B is a general sectional view of the bill processing device 10 in accordance with the present invention. A bill is inserted from a bill insertion port 2 formed on a front mask 24, and is conveyed to the bill path 21. The bent part 11 forms a part of the bill path 21, and refers to the part bent into the convex shape inside the bill processing device 10. The bill inserted from the bill insertion port 2 is conveyed in an upper direction until it reaches the bent part 11, and turns to a different direction in the bent part. According to the embodiment in accordance with the present invention, a plurality of long channels are formed in the bent part.

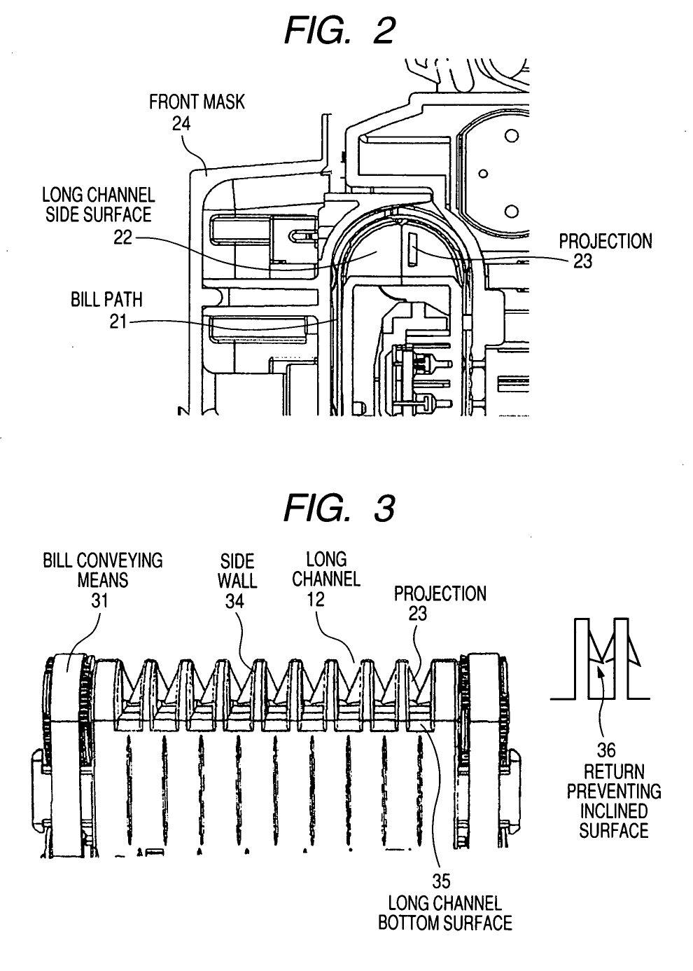

FIG. 2 is an enlarged sectional view of a main part of the bill processing device in accordance with the present invention, and shows the bill path 21, a long channel side surface 22, a projection 23 and the front mask 24. The bill path 21 which communicates with the bill input port formed on the front mask 24 is designed to rise upward until it reaches the bent part 11 when entering the bill processing device 10, and to turn 180 degrees in the bent part 11 and thereafter extend downward. A plurality of long channels 12 are formed on the bent part 11, and at least one projection 23 is formed inside each of the long channels 12.

FIG. 3 is an enlarged view of a main part when the entire image of the bill path 21 shown in FIG. 2 is seen in the direction along the long channel 12, and shows bill conveying means 31, the long channels 12, the projections 23, side walls 34 and long channel bottom surfaces 35. The bill conveyed by the bill conveying means 31 turns to a different traveling direction by 180 degrees as described above, after reaching the bent part 11. A plurality of long channels 12 are provided in parallel with each other in the transverse direction of the bill path 21 so that a foreign matter such as a string or a tape stuck to the bill enters the long channel 12 on this occasion.

The projection 23 has a first surface for guiding the foreign matter such as a string or a tape in the direction of the long channel bottom surface 35 of the long channel 12, and a second surface for preventing the foreign matter which once reaches the long channel bottom surface 35 from exiting from the long channel 12 again, and is provided to extend from the side wall 34 or the bottom surface of the long channel 12. The second surface of the projection 23 described here can be a surface inclined toward the long channel bottom surface 35 as shown in FIG. 3 as a return preventing inclined surface 36, for example. The side wall 34 is a side wall forming the long channel 12. In FIG. 3, the two projections 23 each having a substantially triangular section are arranged on the side walls 34 opposed to each other in the long channel 12, but the shape and the number of the projections 23 are selectable in accordance with the use purpose as described above, and are not limited to the shape and number in FIG. 3.

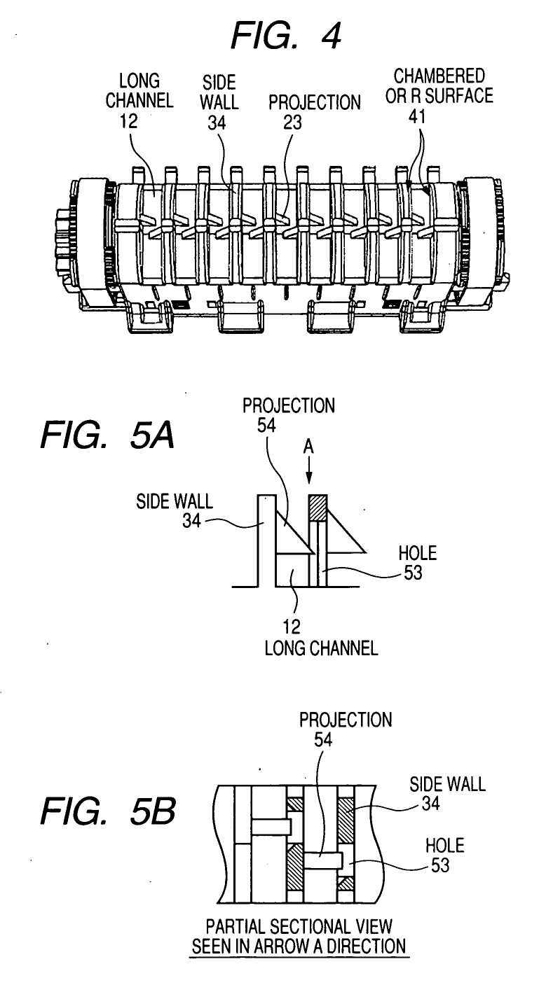

FIG. 4 is an enlarged view of a main part when the bill path 21 shown in FIG. 3 is seen vertically from above with respect to the direction along the long channel 12, and shows chamfered surfaces (or R surfaces) 41, the long channels 12, the projections 23 and the side walls 34. The chamfered surface (or the R surface) 41 is formed on an edge portion of the side wall 34 in the opening side of the long channel 12, and is inclined to the bottom surface side of the long channel 12 to guide a string-shaped or band-shaped foreign matter into the long channel 12. Each of the long channels 12 is formed toward the same direction as the bill conveying direction, the paired projections 23 are disposed to be spaced at a predetermined distance in the direction along the long channel 12 inside the long channel 12, and the sum of the dimensions of the paired projections 23 in the transverse direction of the bill conveying path is designed to be larger than the width of the long channel 12.

The following effect can be expected by arranging the projections 23 to be spaced at a constant distance in the direction along the long channel 12. When the projections 23 are not spaced from each other, a foreign matter is restricted by overlap in the vertical direction with respect to the bill conveying direction of both the projections 23, but the foreign matter can be restricted in the long channel 12 by overlap in the bill conveying direction (horizontal direction) of both the projections 23 by arranging both the projections 23 to be spaced at a constant distance. Incidentally, those who perform an illegal act of drawing out bills not only simply pull out string-shaped or band-shaped foreign matters but also can move the foreign matters in the horizontal direction at the same time. When the movement in the horizontal direction is applied to the foreign matter in the long channel 12 at the time of act of drawing out, the overlap in the vertical direction has the possibility of being incapable of preventing the foreign matter from exiting from the slit. In this respect, according to the embodiment of the present invention, overlap occurs in the direction along the long channel 12, and therefore, such a possibility does not occur. It is also advantageous to the structure with overlap in the direction along the long channel 12 that the foreign matter is in the strained state by its tensile force at the time of illegal act of drawing-out, and especially when the band-shaped foreign matter is used, a higher performance of drawing-out prevention can be expected. Therefore, in the present invention, the projections 23 are arranged to be spaced at a constant distance in the direction along the long channel 12.

FIG. 5A is an enlarged view of a main part of the long channel 12 which is one of a long channel group formed in parallel on the bent part 11 of the bill path 21, and shows the side wall 34 forming the long channel 12, a recessed portion or a hole 53 formed in the side wall 34, and a projection 54 arranged on the side wall 34. The long channel 12 is formed by the side walls 34 opposed to each other. The side wall 34 is arranged vertically upward from the bent part 11 of the bill path 21, and a bill and a string-shaped or a band-shaped foreign matter attached to the bill pass the top end portion thereof. One of the side walls 34 forming the long channel 12 is provided with the recessed part or hole 53. On the other side wall 34 which forms the long channel 12 together, the projection 54 having a substantially triangular section is provided to be inserted up to a predetermined dimension while having a gap between its tip end and an inner wall of the recessed portion or hole 53. The presence of the gap enables a string-shaped or band-shaped foreign matter which is guided into the long channel 12 by the projection 54 to move further to the bottom surface of the long channel 12.

The projection 54 has a first surface which guides a foreign matter into the long channel 12, and a second surface for inhibiting the foreign matter which has entered the long channel 12 from exiting from the long channel 12. The second surface, preferably, the bottom surface of the projection 54 has an inclined portion for promoting prevention of the foreign matter from going outside.

FIG. 5B is a view of the long channel 12, the side wall 34, the hole 53 and the projection 54 seen in the direction of the arrow A shown in FIG. 5A. It shows that the projection 54 is provided to extend from the side wall 34 to the recessed portion or hole 53 provided at the side wall 34 opposed to it, and its tip end is inserted into the recessed portion or hole 53 by a predetermined dimension.

According to this embodiment, when the foreign matter stuck to the conveyed bill enters the long channel 12 without moving on the side wall 34, the foreign matter is guided to the first surface of the projection 54, then reaches the recessed portion or hole 53, and further moves to the bottom portion of the long channel 12 via the gap from the recessed portion or hole 53. Then, the foreign matter which once reaches the bottom portion of the long channel 12 is restricted inside the long channel 12 by the second surface of the projection 54. This is because while the first surface inclined toward the bottom portion of the long channel 12 from the upper portion of the long channel 12 facilitates the movement of the foreign matter in the bottom surface direction of the long channel 12, the second surface of the projection 54 designed to be parallel with the bottom surface of the long channel 12 or preferably to be inclined to the bottom surface side directly hinders the movement of the foreign matter in the direction of the upper portion of the long channel 12 from the bottom portion of the long channel 12.

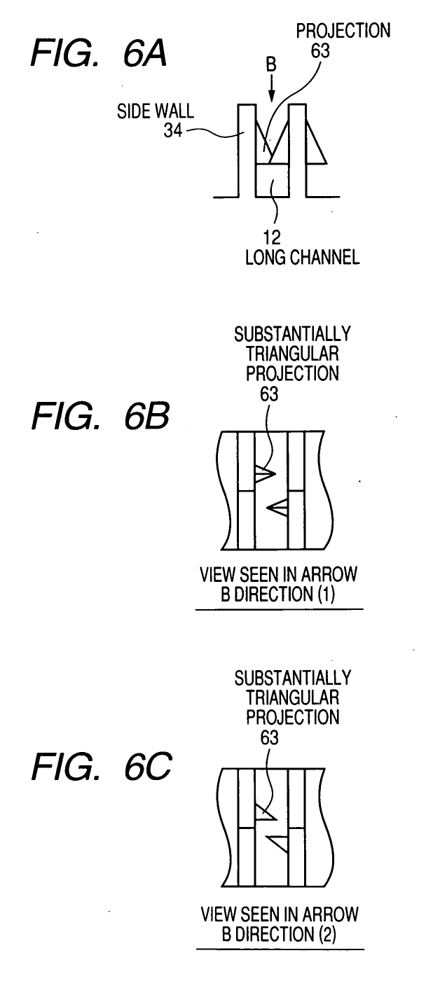

FIG. 6A is an enlarged view of a main part of the long channel 12 which is one of the long channel group formed in parallel on the bent part 11 of the bill path 21, and shows projections 63 which are arranged at the side wall 34 and the side wall 34 which form the long groove 12. In this embodiment, a pair of projections 63 are extendedly provided respectively at the side walls 34 opposed to each other, which form the long channel 12.

Each of the projections 63 has a substantially triangular section, and has a first surface which is inclined to the bottom portion of the long channel 12 from the upper portion of the long channel 12 toward the opposed side wall 34, and a second surface which is parallel with the bottom surface of the long channel 12 or preferably is inclined to the bottom portion of the long channel 12, from the fixed portion to the side wall 34. The projection 63 projects by a predetermined dimension toward the opposed side wall 34, and the predetermined dimension at least partially depends on the width of the long channel 12. Namely, the sum of the dimensions of the paired projections 63 in the transverse direction of the bill path needs to be the width of the long channel 12 or more. If the condition is satisfied, it is possible to adjust the dimension of each of the projections 63 in accordance with the use purpose.

FIGS. 6B and 6C show views of the long channels 12, the side walls 34 and the projections 63 seen in the arrow B direction shown in FIG. 6A. The respective projections 63 which are extendedly provided from the respective side walls 34 of the long channel 12 are arranged to be spaced at a predetermined distance in a direction along the long channel 12 so as not to engage with each other. Thereby, an overlap portion occurs in the horizontal direction along the long channel 12. For each of the projections 63, a single member with a substantially triangular section as shown in FIG. 6C can be used, or the combination of members with substantially triangular sections as shown in FIG. 6B can be adopted.

According to this embodiment, when the foreign matter stuck to the bill which is conveyed enters the long channel 12 without moving on the side wall 34, the foreign matter is guided to the first surface of each of the projections 63, and moves to the bottom portion of the long channel 12. Then, the foreign matter which once reaches the bottom portion of the long channel 12 is restricted inside the long channel 12 by the second surface of each of the projections 63. Namely, at the time of bill drawing-out action, the string-shaped or band-shaped foreign matter is in the strained state by the tensile force, and therefore, it cannot pass the overlap portion in the horizontal direction formed by each of the projections 63. This becomes the effective prevention measure especially against the illegal drawing-out act using a band-shaped foreign matter, and is also advantageous in the respect that it exerts unchanging effectiveness when not only a foreign matter is drawn out but also a force in the horizontal direction is exerted on the foreign matter.

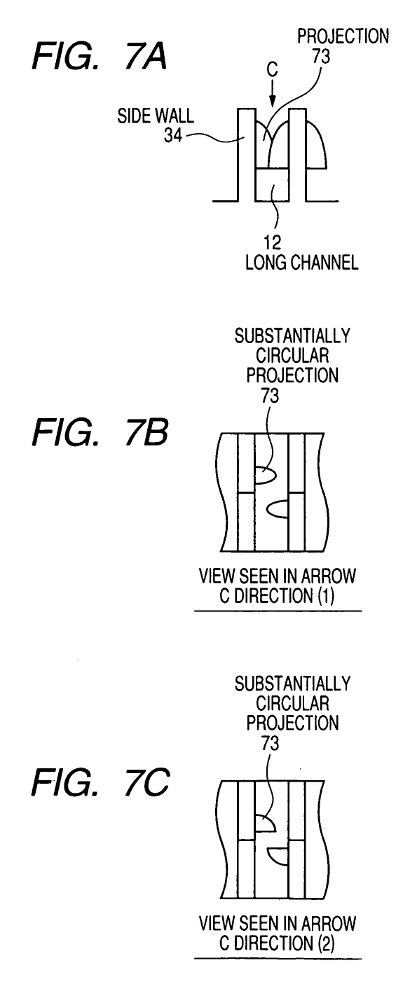

FIG. 7A is an enlarged view of a main part of the long channel 12 which is one of the long channel group formed in parallel on the bent part 11 of the bill conveying path 21, and shows the side walls 34 forming the long channel 12, and projections 73 arranged at the side walls 34. In this embodiment, a pair of projections 73 are extendedly provided respectively at the side walls 34, which form the long channel 12, opposed to each other. Each of the projections 73 has a substantially circular section, and has a first surface inclined to the bottom portion of the long channel 12 from the upper portion of the long channel 12 toward the opposed side wall 34, and a second surface which is parallel with the bottom surface of the long channel 12 or preferably is inclined to the bottom portion of the long channel 12, from a fixed portion to the side wall 34. The projection 73 is projected by a predetermined dimension toward the opposed side wall 34, and the predetermined dimension at least partially depends on the width of the long channel 12. Namely, the sum of the dimensions of the paired projections 73 in the transverse direction of the bill conveying path needs to be the width of the long channel 12 or more. If the condition is satisfied, it is possible to adjust the dimension of each of the projections 73 in accordance with the use purpose.

FIGS. 7B and 7C show views when the long channel 12, the side walls 34 and the projections 73 are seen in the arrow C direction shown in FIG. 7A. The respective projections 73 provided to extend from the respective side walls 34 of the long channel 12 are arranged to be spaced at a predetermined distance in the direction along the long channel 12 so as not to engage with each other. Thereby, an overlap portion occurs in the horizontal direction along the long channel 12. For each of the projections 73, a single member with a substantially circular section as shown in FIG. 7C can be used, or the combination of members with substantially circular sections as shown in FIG. 7B can be adopted.

According to this embodiment, when a foreign matter attached to the bill which is conveyed enters the long channel 12 without moving on the side wall 34, the foreign matter is guided to the first surface of each of the projections 73, and moves to the bottom portion of the long channel 12. Then, the foreign matter which once reaches the bottom portion of the long channel 12 is restricted inside the long channel 12 by the second surface of each of the projections 73. Namely, at the time of the act of drawing out a bill, the string-shaped or band-shaped foreign matter is in the state strained by the tensile force, and therefore, it cannot pass the overlap portion in the horizontal direction generated by each of the projections 73. This becomes the effective prevention measure especially against the illegal drawing-out act using a band-shaped foreign matter, and is also advantageous in the respects that it exerts unchanging effectiveness when not only a foreign matter is drawn out but also a force in the horizontal direction is exerted on the foreign matter.

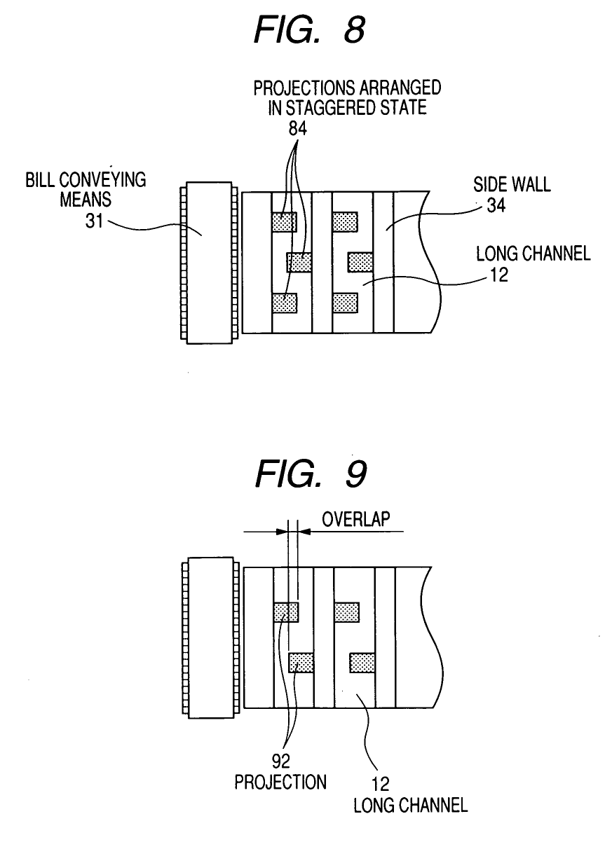

FIG. 8 shows an enlarged view of a main part of the long channels 12, the side walls 34, the bill conveying means 31 and projections 84 which are placed on the bent part 11. As shown in the drawing, two or more projections 84 can be arranged in a staggered state. The overlap portions in the bill conveying direction increases, and therefore, a string can be restricted in the long channel more reliably.

FIG. 9 shows “overlap” mentioned in the specification. The “overlap” in the bill conveying direction refers to the overlapping portion created by respective projections 92 arranged to be spaced in the direction along the long channel 12. The sum of the dimensions of the respective projections 92 in the horizontal direction is larger than the dimension of the width of the long channel 12.

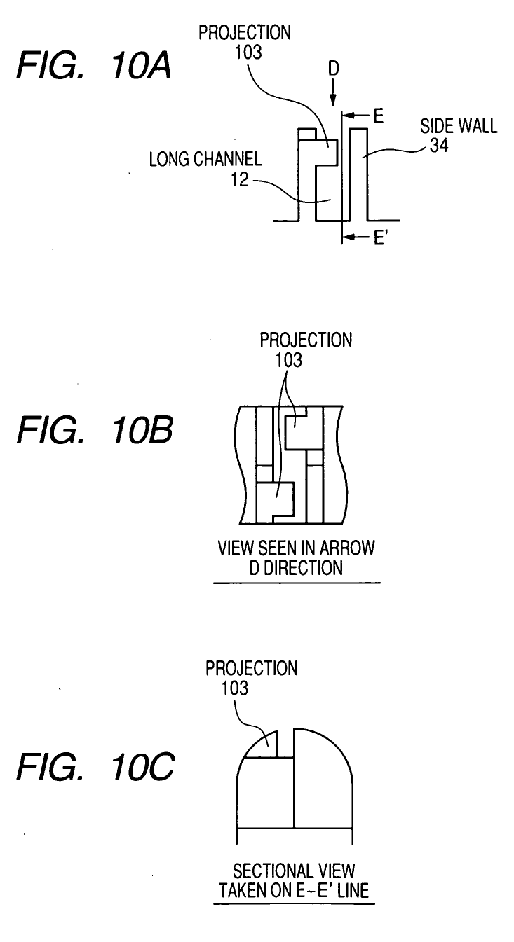

FIG. 10A shows an enlarged view of a main part of the long channel 12, the side wall 34 and a projection 103 which are placed on the bent part 11. In this embodiment, the projection 103 is not arranged at the inner portion of the side wall 34 forming the long channel 12 but arranged at the end surface of the side wall 34. FIG. 10B shows a view of the long channel 12, the side walls 34 and the projections 103 seen in the direction of the arrow D shown in FIG. 10A. The projections 103 are respectively arranged at the end surfaces of the respective side walls 34. FIG. 10C shows a sectional view of a surface taken on the line E-E′ shown in FIG. 10A. Each of the projections 103 is arranged between the bent starting point and a top end portion of the bill path.

Further, it is possible to provide a mushroom-shaped projection (not shown) at the bottom surface of the long channel. The mushroom-shaped projection includes, for example, a support pillar extending from the bottom surface of the long channel, and an umbrella portion which is supported by the support pillar and has a substantially circular section. The umbrella portion has a first surface for promoting entrance of a string-shaped or a band-shaped foreign matter into the inside of the long channel, and a second surface for preventing the foreign matter which once reaches the bottom surface of the long channel from goring outside again.

Both side walls forming the long channel are provided with recessed portions or holes, and part of the umbrella portion of the mushroom-shaped projection arranged at the bottom surface of the long channel is inserted into the recessed portions or the holes. The projections are respectively arranged in the long channels formed in parallel in the transverse direction of the bill path, but the projections are arranged to be spaced in the direction along the long channels respectively, and therefore, the umbrella portions of the adjacent projections do not engage with each other.

What is claimed is:

1. A bill processing device having a bent bill path, comprising:
a long channel disposed on a convexly bent path surface that forms the bill path along a conveying direction of a bill and, wherein a plurality of the long channels are provided in parallel in a transverse direction of the bill path; and
projections extending from respective side walls or bottom surfaces of the plurality of long channels,
wherein said projections each have a first surface inclined to a bottom surface side of the long channel to guide a string-shaped or band-shaped foreign matter conveyed with a bill to enter said long channel, and a second surface horizontal or inclined to the bottom surface side of the channel to inhibit the foreign matter which has entered the long channel from exiting from the long channel.

2. The bill processing device according to claim 1,
wherein said projections are paired and extend from side walls opposed to each other in the long channel;
the paired projections are disposed to be spaced at a predetermined distance in a direction along the long channel;
a sum of dimensions of the paired projections in the transverse direction of the bill path is set to be larger than a width of the long channel.

3. The bill processing device according to claim 1,
wherein one of the side walls of the long channel is provided with a recessed portion or a hole; and
a tip end of said projection extending from the other side wall opposed to the one of the side walls is inserted into the recessed portion or the hole up to a predetermined dimension with a gap between the tip end of the projection and an inner wall of the recessed portion or the hole.

4. The bill processing device according to any one of claims 1 to 3,
wherein an edge portion of said side wall in an open side of the long channel has
an inclined portion inclined to the bottom surface side of the long channel to guide the string-shaped or band-shaped foreign matter conveyed with a bill into the long channel.
